(19) United States
(12) Patent Application Publication
(10) Pub. No.: US 2023/0040684 A1
(43) Pub. Date: Feb. 9, 2023

(54) ADAPTIVELY ADJUSTABLE MATTRESS

(71) Applicant: Zephyr Sleep, Inc., Spokane, WA (US)

(72) Inventors: Sarah Elizabeth Schroeder, Spokane, WA (US); Kathryn Marie Lober, Spokane, WA (US); Jackson Paul Rieb, Spokane, WA (US)

(21) Appl. No.: 17/396,442

(22) Filed: Aug. 6, 2021

Related U.S. Application Data
(60) Provisional application No. 63/259,051, filed on Jan. 1, 0001.

(51) Int. Cl. A47C 27/10; A47C 27/08

(52) U.S. Cl. CPC A47C 27/10; A47C 27/082; A47C 27/083; A47C 27/084; A47C 27/085

(57) ABSTRACT

An adjustable mattress is described herein. The adjustable mattress is comprised of one or more adjustable elements. The adjustable elements may, in some examples, be filled with air or other fluid in order to adjust the height and firmness of the adjustable mattress. The adjustable mattress may provide a user with assistance in rolling over or repositioning while using the adjustable mattress.

This application claims the benefit of and claims priority to U.S. Provisional Application No. 63/259,051, filed on Aug. 9, 2020, which is incorporated herein by reference.

### BACKGROUND

There are over 18 million people in the United States that suffer from some form of mobility impairment, such as amyotrophic lateral sclerosis (ALS), Duchene and Becker muscular dystrophy, severe arthritis, etc. This demographic has not adequately had their concerns about sleep loss addressed. People have a hard time attaining restful sleep.

Separately, it has been found that over 25% of hospital injuries are caused by moving mobility impaired patients, costing hospitals and care facilities over $2 billion a year. The current standard of moving patients with two nurses and a bedsheet causes severe strain on the nurses' backs, leading to injury. It is also difficult on the patients themselves, who can suffer from emotional trauma from the event.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1. illustrates an example environment in which a mattress is operating, in accordance with one or more examples.

FIG. 2 illustrates an example user interface.

FIGS. 3A-3D illustrate an example adjustable element having a bellowed structure.

FIG. 4 illustrates an example adjustable element having a bellowed structure with curved corners.

FIG. 5A illustrates an example adjustable element in an inflated cell state.

FIG. 5B illustrates an example support structure.

FIG. 6 is a block diagram illustrating components of an adjustable element, in accordance with one embodiment.

FIG. 7 is a flow chart illustrating an example process 700 for employing the techniques described herein.

FIG. 8 illustrates an example roll assist mechanism.

### DETAILED DESCRIPTION

This application describes a highly customizable mattress that meets the needs of mobility impaired users, which allows them to control the firmness of each pressure point to relieve localized pain and provides assistance in rolling or repositioning themselves in bed. By allowing users to control the bed themselves, users feel empowered, which provides more independence, and reduces emotional stress. However, the mattress may additionally or alternatively be controlled by hospital staff or other caregivers. In some examples, the mattress may be programmed to adjust according to a preset schedule, or the mattress may be configured to “learn” user preferences and to adjust automatically based on the user preferences learned over time.

The mattresses described in this application includes multiple adjustable elements spaced throughout all or part of the support surface of the mattress. The number, spacing, and construction of the adjustable elements may vary depending on a variety of factors such as, for example, size of the mattress, the intended use (e.g., in-home, care facility, hospital, etc.), and functionality desired.

As described herein, the adjustable elements may comprise pneumatics, hydraulics, or mechanical elements. In the case of pneumatics, the adjustable elements may comprise inflatable cells that can be inflated by an air source (e.g., a centrifugal pump, air compressor, tank of compressed gas, etc.) and deflated by an air exit (e.g., a purge valve, exhaust, vent, pump, fan, vacuum, etc.). In the case of hydraulics, the cells are filled with fluid (water, oil, gel, etc.), and can be inflated by a hydraulic source (e.g., pump, cylinder, etc.) drawing fluid from a reservoir, and can be deflated by an fluid exit (e.g., a purge valve, exhaust, vent, pump, etc.). In the case of mechanics, one or more mechanical elements (e.g., pins, plates, rods, beads, etc.) can be moved upwards or downwards by a motor or actuator to increase or decrease the firmness of the sleeping surface.

In one specific example using inflatable cells, a bellowed cell design is inflated by a centrifugal pump, the pressure is read by a pressure sensor, and adjustments to pressure are made by inflating or deflating the cells (by pump or purge valve respectively). The bellowed cell design in this example allows for increased vertical articulation for the roll mechanism and greater variability in firmness settings. The bellows may be actuatable between a fully compressed state and a fully extended state. In some examples, a top of each bellows may be configured to travel substantially vertically between the fully compressed and fully extended states. However, in other examples, a top of some or all of the bellows may be configured to travel in in a non-vertical motion for at least a portion of the travel. The non-vertical motion of the top of the bellows may be linear (e.g., the top surface travels at an oblique angle relative to vertical) or non-linear (e.g., the top surface of the bellows travels in an arcuate motion). In some examples, some or all of the bellows may be configured such that a top surface travels in a substantially vertical motion for at least a portion of their travel, and then to transition to traveling in a non-vertical motion.

In some examples, the bellows may be adjustable between a height of about 0.05″ in a fully compressed state and about 24″ in a fully inflated state, and to any height in between. In some examples, the fully compressed height can be more or less than 0.05″ and the fully extended height can be more or less than 24″. In one specific example, the bellows can be inflated to reach 10″ in total height when fully inflated and can deflate to 0.0625″ when fully deflated.

Mattresses according to this application may have any number of adjustable elements. The more adjustable elements that are provided, the greater the degree of adjustability that the mattress will be able to provide. For instance, for a given size mattress, a greater number of adjustable elements enables finer adjustments of the mattress (e.g., changing the positions of smaller regions of the mattress). In that sense, for the given size, a larger number of adjustable elements provides a higher resolution of adjustment. By way of example and not limitation, example twin size mattresses according to this application may have between 24 and 100 adjustable elements, full size mattresses according to this application may have between 48 and 200 adjustable elements, example queen size mattresses according to this application may have between 48 and 300 adjustable elements, and example king size mattresses according to this application may have between 75 and 400 adjustable elements. In some particular examples, a twin-size mattress may have 24-48 adjustable elements, a full size mattress may have 48-100 adjustable elements, a queen size mattress may have 48-150 adjustable elements, and a king size mattress may have 75-200 adjustable elements. However, these specific examples are merely illustrative examples and it should be understood that mattresses according to this application may have more or fewer numbers of adjustable elements.

In some examples, the adjustable elements may be distributed evenly below a support surface of the mattress. However, in other examples, the adjustable elements may be distributed nonuniformly. For instance, in some examples there may be different concentrations and/or spacings between adjustable elements in some locations than in others. For example, there may be a greater concentration of adjustable elements near a center of the mattress than at the edges, there may be a greater concentration of adjustable elements in regions of higher anticipated loading such as where a user's head, back, abdomen, etc. are expected to be located during use, than at locations of lower anticipated loading such as where a user's feet are expected to be during use.

In some examples, the adjustable elements may be distributed below all of the support surface of the mattress, while in other examples adjustable elements may be disposed in some portions but not in other portions. For instance, adjustable elements may be localized in one or more portions of the mattress.

In some examples, the adjustable elements may be the same configuration throughout the mattress. However, in other examples, different sizes, shapes, and/or constructions of adjustable elements may be used at different locations of the mattress (e.g., adjustable elements in a first region (e.g., near a longitudinal and/or lateral center of the mattress) may be larger, longer, and/or more robust than adjustable elements in a second region (e.g., near a head and/or foot of the bed, at lateral sides of the bed, etc.). Any number of different sizes, shapes, and/or constructions of adjustable elements can be used in any number of different regions (e.g., 1, 2, 3, 5, 10, etc.) of the mattress.

Different shapes may include, for example, circular bellows, rounded-rectangular bellows, and/or rectangular bellows.

In some examples the amount and type of cushioning material above and/or below the adjustable elements may be the same. However, in other examples the cushioning above the elements may be thicker than below or vice versa. The type of cushioning may be comprised of any number of elements (e.g., foam, gel, fabric, padding, mesh, memory foam, polymers) alone or combined. These elements may be located in in some areas of the bed but not in others (e.g., a combination of gel and foam under the lower back and only foam at the foot of the bed). In some examples these cushioning materials may include embedded heating and/or cooling elements (e.g., wires, fluid and/or air tubes).

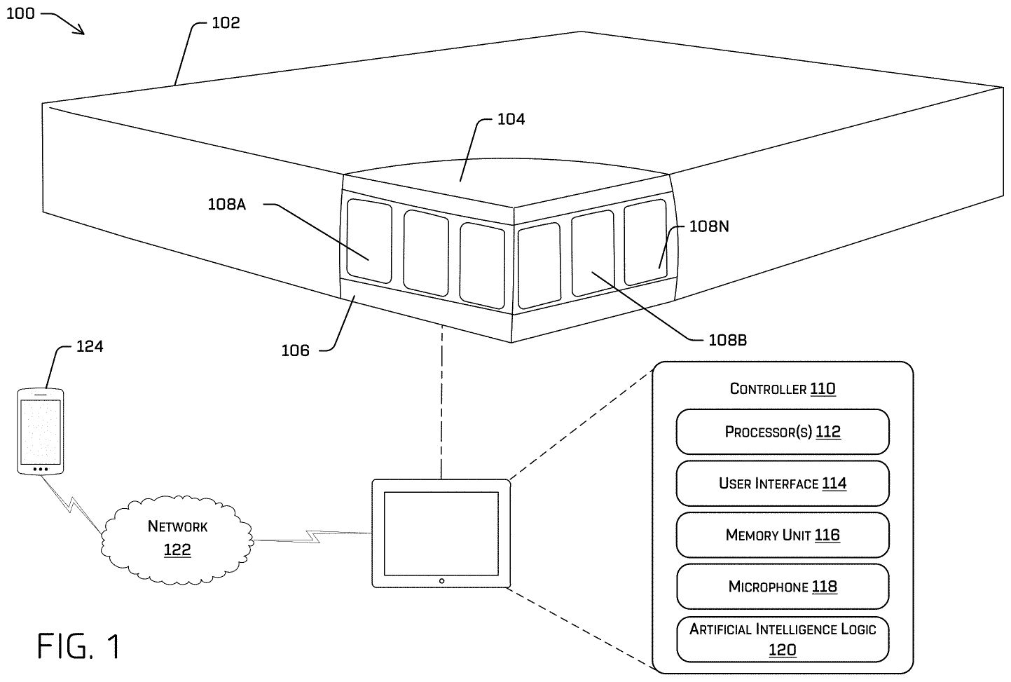

FIG. 1 illustrates an example environment 100 in which techniques herein may be implemented. The environment 100 includes a mattress 102 that may include a top surface 104 and a bottom surface 106. The mattress 102 includes multiple adjustable elements 108A, 108B, . . . 108N, where N is any integer greater than 1 (collectively adjustable elements 108″) spaced between the top surface 104 and the bottom surface 106. The multiple adjustable elements 108N may be controlled using a controller 110. The controller may be integrated with, coupled to, or remote from the mattress 102. In some examples, the number, spacing, and construction of the adjustable elements 108N varies depending on a variety of factors such as, for example, size of the mattress 102, the intended use (e.g., in-home, care facility, hospital, etc.), and functionality desired.

As described herein, the adjustable elements 108N may comprise of cells that include one or more pneumatics, hydraulics, or mechanical elements. In some examples, the one or more cells may fill with air and inflate with a centrifugal pump and deflate with a purge valve. In some examples, the cells may fill with fluid (water, oil, gel, etc.), inflate with a hydraulic pump and deflate with a purge valve. In some examples, pins or plates move upwards or downwards to increase or decrease the firmness of the sleeping surface. In some examples, the adjustable elements 108N comprise of inflatable cells. The inflatable cells may have a bellowed cell design and inflate via a centrifugal pump. The pressure in the inflatable cell may be read by a pressure sensor, and adjustments to pressure may be made by inflating or deflating the inflatable cell (via a pump or purge valve respectively.)

The adjustable elements 108N may have a bellowed cell design, which allows for increased vertical articulation for a roll mechanism and greater variability in firmness settings. In the illustrated example, the bellowed cell design allows for the cells to reach 10″ in total height when fully inflated and to deflate to 0.0625″ when fully deflated.

The adjustable elements 108N may have structural supports 504 to ensure that the cell inflates and deflates in a repeatable and uniform fashion. In one example the structural support 504 for the adjustable elements 108N is where the two halves of the element meet. This support may be made of various materials (e.g., vinyl, plastic, rubber, nylon, rope, spandex, etc.). In one example the structural supports 504 include an additional piece of vinyl with a hole in the middle to allow air to flow between the two halves.

A mattress 102 according to this application may have any number of adjustable elements 108N. The more adjustable elements 108N that are provided, the greater the degree of adjustability that the mattress 102 will be able to provide. For instance, for a given size mattress, a greater number of adjustable elements 108N enables finer adjustments of the mattress 102 (e.g., changing the positions of smaller regions of the mattress). In that sense, for the given size, a greater number of adjustable elements 108N provides a higher resolution of adjustment. By way of example and not limitation, example twin size mattress according to this application may have between 24 and 100 adjustable elements 108N, full size mattresses according to this application may have between 48 and 200 adjustable elements 108N, example queen size mattresses according to this application may have between 48 and 300 adjustable elements 108N, and example king size mattresses according to this application may have between 75 and 400 adjustable elements 108N. In some examples, a twin-size mattress may have 24-48 adjustable elements 108N, a full-size mattress may have 48-100 adjustable elements 108N, a queen size mattress may have 48-150 adjustable elements 108N, and a king size mattress may have 75-200 adjustable elements 108N. However, these examples are merely illustrative examples and it should be understood that mattresses according to this application may have more or fewer numbers of adjustable elements 108N.

In some examples, the number of adjustable elements 108N is chosen due to the size of the pressure points on the human body and/or the size of the mattress 102. The typical pressure points on a human body are at the hips, shoulders, elbows, and calves and each pressure point fits within about a 10″ square space. A queen mattress may therefore have about 48 10″×10″ adjustable elements 108N and twin mattress may have half as many adjustable elements (24 10″×10″ adjustable elements 108N).

In some examples, the adjustable elements 108N may be distributed evenly below a top surface 104 of the mattress 102. In other examples, the adjustable elements 108N may be distributed nonuniformly below a top surface 104. For example, there may be different concentrations and/or spacings between adjustable elements 108N in some locations than in others. In some examples, there may be a greater concentration of adjustable elements 108N near a center of the mattress 102 than at the edges, and/or there may be a greater concentration of adjustable elements 108N in regions of higher anticipated loading such as where a user's head, back, abdomen, etc. are expected to be located during use, than at locations of lower anticipated loading such as where a user's feet are expected to be during use.

In some examples, the adjustable elements 108N may be distributed below the support surface 104 of the mattress 102, while in other examples adjustable elements 108N may be disposed in some portions but not in other portions bellow the support surface 104. For instance, adjustable elements 108N may be localized in one or more portions of the mattress 102.

In some examples, the adjustable elements 108N may be in the same configuration throughout the mattress. However, in other examples, different sizes, shapes, and/or constructions of adjustable elements 108N may be used at different locations of the mattress 102 (e.g., adjustable elements 108N in a first region (e.g., near a longitudinal and/or lateral center of the mattress 102) may be larger, longer, and/or more robust than adjustable elements 108N in a second region (e.g., near a head and/or foot of the bed, at lateral sides of the bed, etc.). Any number of different sizes, shapes, and/or constructions of adjustable elements 108N can be used in any number of different regions (e.g., 1, 2, 3, 5, 10, etc.) of the mattress 102. Different shapes may include, for example, circular bellows, rounded-rectangular bellows, and/or rectangular bellows.

In some examples, the adjustable elements 108N may be independently inflated and deflated. In some examples, there is no limit to the height adjustment of adjacent adjustable elements 108N. In some examples, adjacent adjustable elements 108N may be limited to maintaining a height of ±1 inch of each other. In some examples, the adjustable elements 108N detect movement of adjacent adjustable elements 108N and make a coordinated effort to provide localized support. The area of effect the adjustable elements 108N react to stimuli with is an adjustable parameter that the user may customize to a preference. The adjustable elements 108N may act individually, as a particular group(s), or as a whole to best support the user in increasing mobility and reducing pressure points

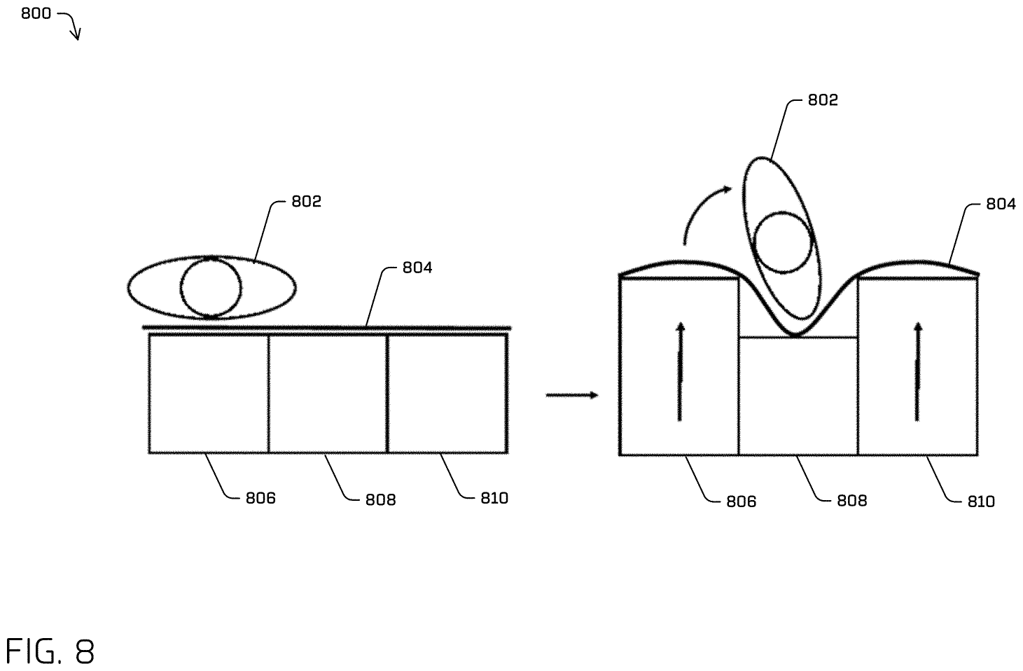

The adjustable elements 108N have an articulation of 9.9375″ vertically from complete deflation to maximum inflation (0.0625″ completely deflated to 10″ completely inflated). The adjustable elements 108N may be inflated/deflated to any height within the range 0.0625″-10″. This articulation allows for dynamic movements to be facilitated with the adjustable elements 108N. The adjustable elements 108N range of motion can be seen in FIG. 8 in relation to the roll mechanism 800.

In some examples, the adjustable elements 108N are constructed using roto-molding with PVC for the top and bottom, and a 3D printed model covered in a sprayable pond liner material for the sides. In some examples, the adjustable elements 108N may be molded by other plastic polymers (e.g. high-density polyethylene, PVC, EPDM, etc.). In some examples, the adjustable elements 108N may be constructed with injection molding. The walls of the adjustable elements 108N may be between 0.1 mm and 1 mm thick. In some examples, the adjustable elements 108N may be constructed with vinyl fabric that is either fused mechanically using heat or with an adhesive.

In some examples, the top surface 104 and the bottom surface 106 of the mattress 102 are comprised at least in part of a cushioning material. For example, the cushioning material may be foam and/or gel. In some examples, the amount and type of cushioning material above and/or below the adjustable elements 108N may be the same. However, in other examples, the cushioning material in the top surface 104 above the adjustable elements 108N may be thicker than cushioning material in the bottom surface 106 located below the adjustable elements 108N or vice versa. In some examples, the type of cushioning material may be foam and/or gel in some areas but not in others (e.g., a combination of gel and foam under the lower back and only foam at the foot of the bed).

In some examples, the adjustable elements 108N may be controlled using a controller 110. The controller may include one or more processor(s) 112, a user interface 114, a memory unit 116, a microphone 118, and artificial intelligence logic 120.

By way of example and not limitation, the processor(s) 112 may comprise one or more central processing units (CPUs), graphics processing units (GPUs), or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

The one or more processor(s) 112 may include one or more of a central processing unit (CPU), a graphics processing unit (GPU), a microprocessor, a digital signal processor, Alternatively, or in addition, the processing described herein can be performed, at least in part, by one or more hardware logic component(s). For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each processor(s) 112 can possess its own local memory, which also can store programs, program data, and/or one or more operating system(s). Furthermore, the processor(s) 112 can include one or more core(s).

The memory unit 116 (also referred to as “memory”) is an example of non-transitory computer-readable media. The memory unit 116 may store an operating system and one or more software applications, instructions, programs, and/or data to implement the methods described herein and the functions attributed to the various systems. In various implementations, the memory unit 116 may be implemented using any suitable memory technology, such as static random-access memory (SRAM), synchronous dynamic RAM (SDRAM), nonvolatile/Flash-type memory, or any other type of memory capable of storing information. The architectures, systems, models, algorithms, and individual elements described herein may include many other logical, programmatic, and physical components, of which those shown in the accompanying figures are merely examples that are related to the discussion herein.

The memory unit 116 may include volatile and nonvolatile memory and/or removable and non-removable media implemented in any type of technology for storage of information, such as computer-readable instructions, data structures, program modules, or other data. Such computer-readable media can include, but is not limited to, random access memory (RAM), read-only memory (ROM), electrically erasable programmable read-only memory (EEPROM), flash memory or other memory technology, optical storage, solid state storage, magnetic tape, magnetic disk storage, redundant array of independent disks storage systems, storage arrays, network attached storage, storage area networks, cloud storage, or any other medium that can be configured to store the desired information and that can be accessed by the controller 110. The memory unit 116 can store an operating system and one or more software application(s), instructions, programs, and/or data to implement the methods described herein and the functions attributed to the various examples.

The user interface 114 may include a touch screen, touch pad, or other physical user interface, a graphical user interface displayed on a display screen associated with the mattress or a mobile device of the user, and/or a natural user interface comprising one or more cameras, microphones, biometric sensors (e.g., temperature, heart rate, blood pressure, oxygen saturation, etc.), or other sensors configured to detect gestures, motion, gaze direction, voice commands, biometric data, or other inputs.

The artificial intelligence logic 120 may comprise models, algorithms, or other logic which are trained based on training data to perform one or more operations in response to one or more inputs. Examples of artificial intelligence logic can include, without limitation, regression models, decision trees, random forest, support vector machines, learned vector quantization, k-nearest neighbor, Bayesian models, neural networks, deep learning, or other machine learned models, logic, algorithms, or other logic configured to perform one or more operations in response to one or more inputs. In some examples, the training data may include stored sensor data annotated with ground truth to control one or more characteristics of the mattress (e.g., pressure, relative height of multiple different portions of the mattress, temperature, etc.) based at least in part on inputs from one or more sensors. In various examples, the inputs may include measured positions/heights of different portions of the mattress, pressure of adjustable elements of the mattress, temperature of one or more portions of the mattress, motion of a user, vitals data of the user (e.g., heart rate, temperature, blood pressure, breathing, position and limb movements, etc.). In some examples, the ground truth may be obtained by one or more human users labeling stored log data (e.g., comprised of historical sensor data) to indicate which conditions or set of conditions correspond to or are associated with an operation to be taken (e.g., a left turn operation, a right turn operation, a pressure reduction operation, a pressure increase operation, a pressure sore prevention operation, an increased circulation operation, a slight shift operation, a rocking motion operation, etc.).

In some examples, the controller 110 is directly connected to the mattress. In some examples, the controller 110 is configured to connect to a network 122 and is configured to control the adjustable elements 108N remotely. The controller 110 may also be configured to make a Bluetooth connection and connect to WIFI. In some examples, the adjustable elements 108N may be controlled via a remote computing device 124 that is configured to connect to a network 122.

The controller 110 may include or be communicatively coupled to a microphone 118. In some examples, the controller may receive a voice command via the microphone 118 to control a characteristic of one or more of the adjustable elements 108N. In other examples, the controller 110 may receive other requests or commands via the user interface 114, microphone 118, and/or other inputs (e.g., camera, sensors, communication connections, etc.).

In some examples, the mattress 102 may generally implement artificial intelligence logic 120 to perform a variety of operations. The artificial intelligence logic 120 may include machine learning (also referred to, generally, as machine learned models), such as one or more neural networks. For example, the mattress 102 may analyze data generated by the pressure sensors 610, temperature sensor(s) 614, or a user's vitals data (e.g., heart rate, temperature, blood pressure, breathing, position and limb movements) to automatically respond to certain events or stimuli (e.g., changes in time, user's movements or change in vitals, etc.).

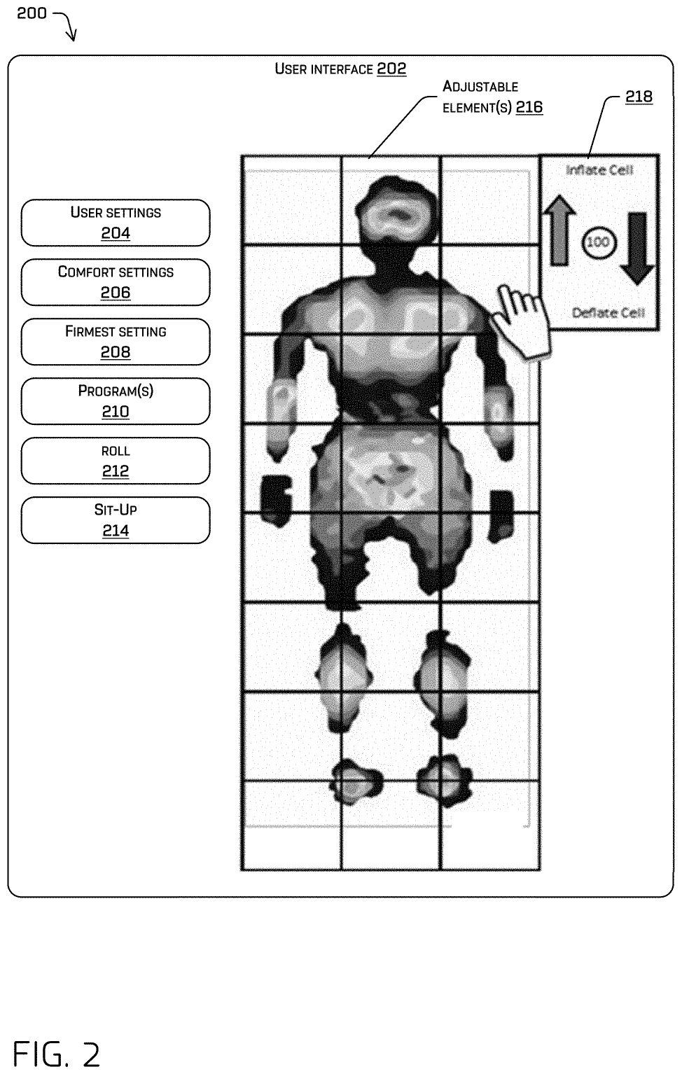

FIG. 2 illustrates a display screen 200 of an example user interface 202 that may be presented to a user of the mattress 102. The display screen 200 may comprise a touch screen, in which case all or part of the user interface 202 may be a soft interface including one or more graphical icons or buttons that are selectable by the user touching the touch screen. Alternatively, the display screen 200 may be a non-touch screen, in which case the user interface 202 may be implemented as physical interface including a physical touch pad, buttons, knobs, or other physical controls. The user interface 202 may present the user with multiple selectable options including user settings 204, comfort settings 206, firmest setting 208, program(s) 210, and/or a menu 218 to inflate or deflate the adjustable element(s) 216. The user interface 202 may also present different command options, such as roll 212 and/or sit-up 214. The user interface 202 may also present all of the adjustable element(s) 216 that are available to be controlled and/or adjusted using the user interface 202. For example, the user interface 202 presents 24 adjustable element(s) 216 and a menu 218 used to inflate or deflate the adjustable element(s) 216.

In some examples, the user interface 202 may be integral with, coupled to, or otherwise associated with a mattress (e.g., mattress 102). In some examples, the user interface 202 may be accessible via a computing device separate and/or remote from the mattress. The user interface 202 may be displayed through a browser, an application (e.g., a client application), and so forth. In some examples, the user interface 202 may be accessible via a mobile device of the user.

The selectable options displayed on the user interface 202 may be selected via a touchscreen. In one example, the user may use voice recognition software, such as those available from Apple® (e.g., Siri®), Google®, or Amazon® (e.g., Alexa®) to control certain features of the mattress 102. For example, the user may say a wake word, such as “Hey Zephyr,” and then a command such as “sit me up” or “inflate cell 23” and the mattress 102 will do so. In some examples, certain options and features of the mattress 102 may be controlled using voice commands. This removes the need for the user to operate the user interface 202 manually.

A user may select the adjustable element(s) 216 presented on the user interface 202 individually, or the user may select multiple adjustable element(s) 216 at one time. For example, the user may select a row of adjustable element(s) 216 or a column of adjustable element(s) 216. The user may control the pressure of the adjustable element(s) 216 individually, or the user may control the pressure of a group of selected adjustable element(s) 216. Selecting more than one of the adjustable element(s) 216 enables the user to change the area of effect by changing the characteristics (e.g., the pressure or temperature) of the selected adjustable element(s) 216 at the same time.

In some examples, the mattress 102 may be compatible with the Internet of Things (IoT) and the user interface 202 may be available through an application on a computing device or a smart device (e.g., smartphone, tablet, etc.). The mattress 102 may operate with Bluetooth technology to wirelessly communicate with a computing device 124 and/or the controller 110. The user may be able to control the mattress 102 completely with a computing device 124 and eliminate the need for a user interface directly wired to the mattress 102.

The user settings 204 enable the user to select the desired firmness of any and all adjustable element(s) 216, increase one or many adjustable element(s) 216 at one and change the firmness, select height of the bed 102, select the area of affect (one or many adjustable element(s) react to user input), select their stimulus sensitivity (how much change in pressure compared to change in time is needed to activate the elements 216), select to allow for the adjustable element(s) 216 to respond to a stimulus automatically, and customize their default settings. In some examples, user settings 204 may include preferences on using voice commands/eye tracking technology to control the system. In some examples these settings 204 may also allow users to change the temperature of one or many adjustable element(s) 216.

In some examples, the mattress 102 may track the user's preferences and user settings (e.g., cell firmness, how often to shift the user, temperature, etc.) and use this data to predictively adjust the one or more adjustable elements 108N without a user command. The mattress 102 may apply machine learning techniques to determine how best to respond to certain events or conditions (e.g., when the user beings to move more during sleep). This learning capability may also be employed in tracking motion of the user during sleep and actively adjusting. For example, the mattress 102 may sense the restless movement of a user and automatically lower the temperature of the mattress 102. In some examples, machine learning techniques may be used to update a user's preferences automatically over time or to generate new comfort setting options based on frequently used user settings.

The comfort settings 206 enables a user to set a predetermined comfort setting. The comfort setting 206 may also enable the user to set a predetermined pressure when the adjustable element(s) 216 are activated. In some examples, the comfort setting 206 may be adjusted automatically using machine learning techniques and tracked preferences over time. For example, the mattress 102 may use machine learning techniques to track what temperatures and/or pressure settings a user prefers during certain times of the day, days of the week, or even during certain months of the year (e.g., a user might prefer cooler temperatures during the summer months).

The comfort settings 206 may vary for each individual adjustable element. In some examples, the comfort settings 206 may be the same across a portion or group of the adjustable elements. For example, if two users are sharing one mattress, the comfort settings 206 may be different for each side of the mattress 102 depending on the preferences of each user.

The firmest setting 208 enables the user to set the maximum pressure that the adjustable element(s) 216 can inflate to when the adjustable element(s) 216 are activated, either through a pressure change over time or through the user interface 202.

The program(s) 210 enable the user to update their user setting preferences to allow for the adjustable element(s) 216 to respond to a stimulus automatically. For example, a stimulus may be a specific pressure, a temperature, a user's vitals (heart rate, temperature, blood pressure, breathing, position and limb movements) or a specific time or day. The stimulus may also be a range of pressures or temperatures. If a stimulus is detected, the adjustable element(s) 216 will respond by deflating and/or inflating automatically. User settings can also allow users to create unique preset programs (e.g., inflate cells 1, 4, and 8). In some examples users can set a numerical value through the graphic user interface for their “comfortable firmness” (what firmness the surface rests at), “max firmness” (what the system changes to when the user needs to adjust their position), “area of effect” (how much of the surface reacts to a single stimulus), and “sensitivity” (how much change in pressure over how much time results in a perceived stimulus). In some examples, the mattress 102 may be programmed to adjust according to a present schedule, or the mattress 102 may be configured to learn user preferences and to adjust automatically based on the user's preferences learned over time.

The roll 212 command enables the user to enact a roll assist movement or mechanism of the mattress 102 through the user interface 202 at any given time. In one example, the user may set the roll 212 command to repeat after a given amount of time (e.g., every 15 minutes). The user may also set the roll 212 command to occur at a specific time and/or day (e.g. at 9 am in the morning on Mondays and at 10 am in the morning on Saturdays).

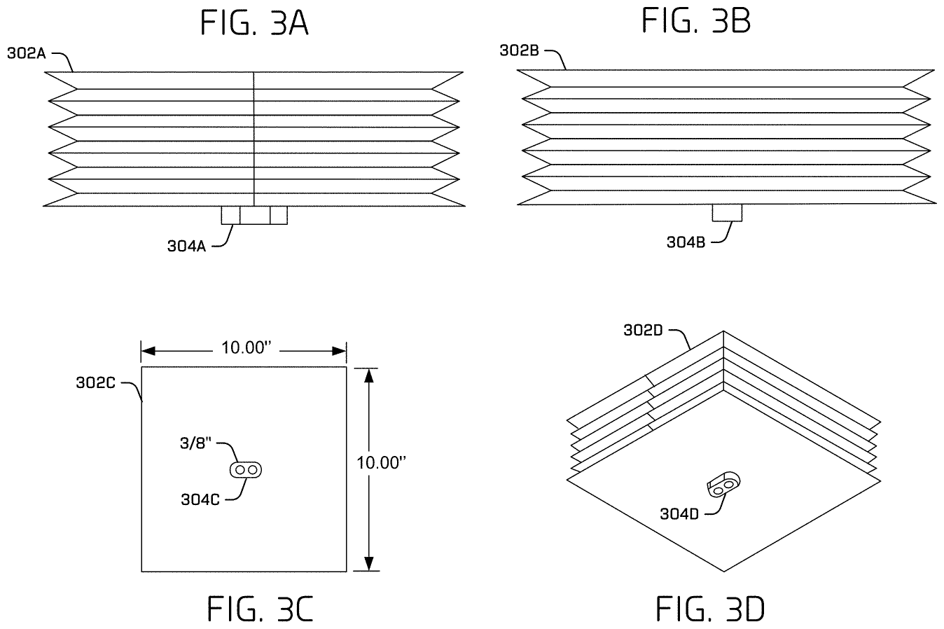

FIGS. 3A-3D illustrate an example adjustable element 302A, 302B, 302C, 302D, . . . 302M, where M is any integer greater than 1 (collectively “adjustable elements 302”) having a bellowed structure from multiple views. The adjustable element 302C may have a top surface and a bottom surface and may be about 10.00″ long and 10.00″ wide. The bellowed structure of the example adjustable element 302A allows the adjustable element 302A to reach about 10.00″ in total height while fully inflated and about 0.0625″ when fully deflated. The adjustable element 302A may have an inflation/deflation port 304A-304D located on the top and/or bottom surface of the adjustable element 302A. The inflation/deflation port 304A-304D may be about ⅜″ long. The bellowed structure of the example adjustable element 302A allows for increased vertical articulation when a roll mechanism is activated (depicted in FIGS. 8A-8B).

The bellowed structure of the adjustable element 402 may be actuatable between a fully compressed state and a fully extended state. In some examples, a top surface of the adjustable element 402 may be configured to travel substantially vertically between the fully compressed and fully extended state. However, in other examples, a top surface of the adjustable element 402 may be configured to travel in a non-vertical motion for at least a portion of the travel. The non-vertical motion of the top surface of the adjustable element 402 may be linear (e.g., the top surface travels at an oblique angle relative to vertical) or non-linear (e.g., the top surface of the adjustable element 402 travels in an arcuate motion). In some examples, the adjustable element 402 may be configured such that a top surface travels in a substantially vertical motion for at least a portion of its travel, and then to transition to traveling in a non-vertical motion.

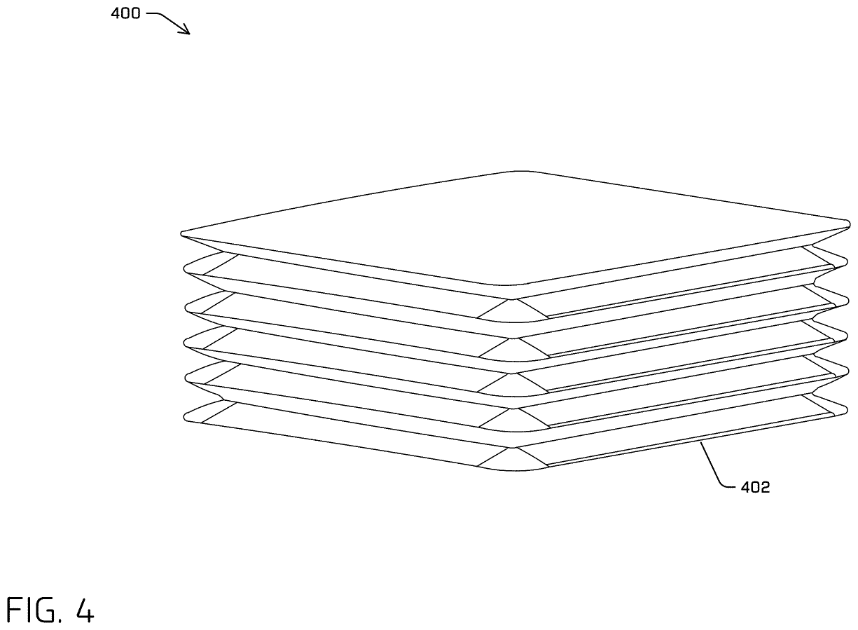

FIG. 4 illustrates an example adjustable element 402 with a bellow structure including corners that have curved edges in order to increase stability and safety.

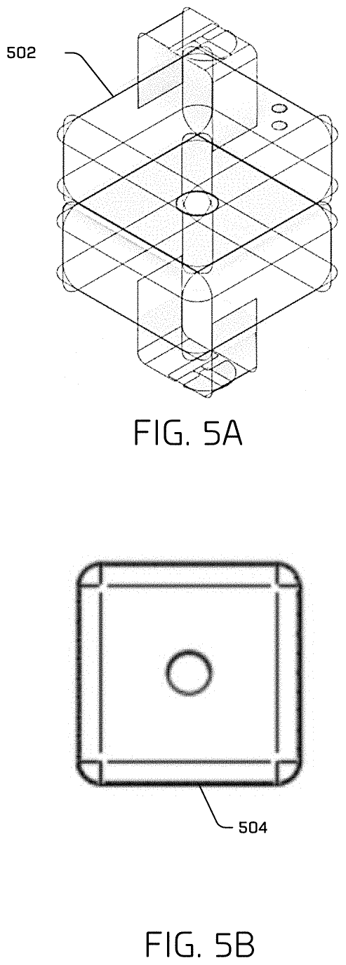

FIG. 5A illustrates an example adjustable element 502 in an inflated state. The adjustable element 502 may have one or more support structures that increase structural integrity of the adjustable element 502.

FIG. 5B illustrates an example support structure 504. The support structure 504 ensures that the adjustable element 502 inflates and deflates the same way every time. The support structure 504 may be located where the two halves of the adjustable element 502 meet. The support structure 504 may be located inside one or more portions of the adjustable element 504 or may be located between the two halves of the adjustable element 502. In some examples, the support structure 504 may be an additional piece of fabric or vinyl with a hole in the middle to allow air to flow between the two halves of the adjustable element 502. In some examples, the support structure 504 may comprise in whole or in part of vinyl, plastic, rubber, and/or textiles such as nylon rope, spandex, etc.

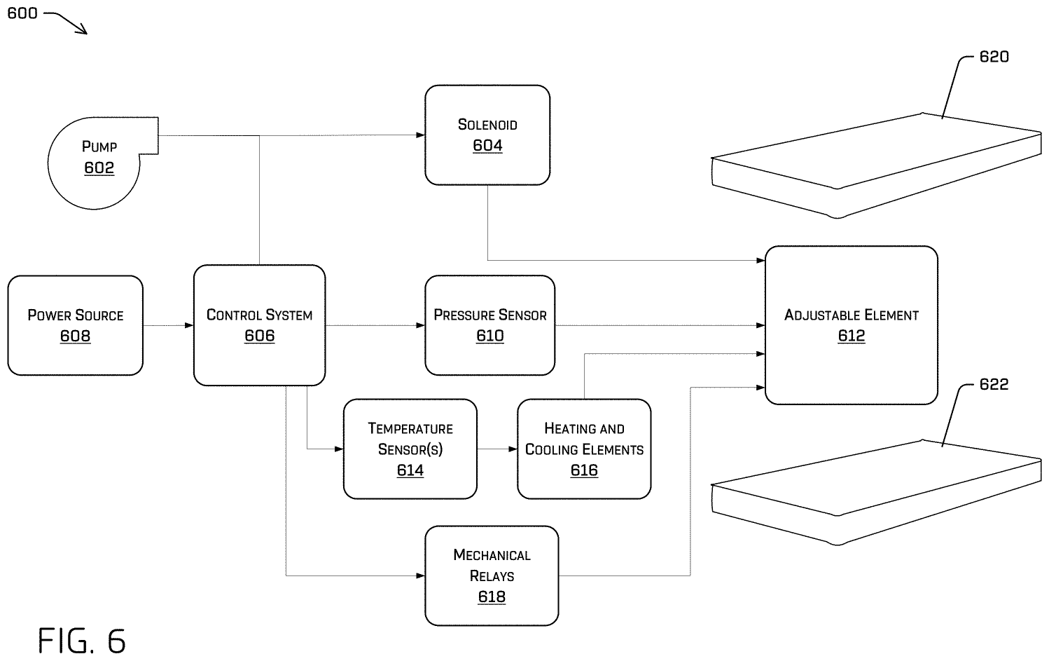

FIG. 6 is a block diagram illustrating components of an adjustable element 612, in accordance with one embodiment. The adjustable element 612 may be disposed between a top surface 620 and a bottom surface 622. The example system 600 may include a pump 602, solenoid(s) 604, a control system 606, a pressure sensor 610, temperature sensor(s) 614, heating and cooling element) 616, a power source 608, and/or mechanical relays 618.

The adjustable element 612 may detect movement by comparing a change in pressure within the adjustable element to a change in time.

The pump 602 may be a centrifugal pump. In some examples, the adjustable element 612 is inflated using an air compressor, tank of compressed gas, etc. and deflated by an air exit (e.g., a purge valve, exhaust, vent, pump, fan, vacuum, etc.).

The pressure sensor 610 measures the internal pressure of the adjustable element 612.

The solenoid 604 is coupled to the pump 602 and the control system 606 and enables air to flow into the adjustable element 612 so that it can inflate the adjustable element 612 to a specified firm setting (e.g., 3 psi). The user may determine what internal pressure the adjustable element 612 should inflate to. The solenoid 604 may close once the pressure sensor 610 detects that the desired pressure has been achieved. The user may determine a duration of time that the adjustable element 612 remains at a desired pressure. In some examples, the duration is 10 seconds. After the duration of time has passed, the solenoid 604 opens venting pressure to the atmosphere until the pressure sensor 610 detects that the pressure in the adjustable element 612 has decreased to the user's determined comfortable setting (e.g., 0.05 psi) if no further movement is detected.

The control system 606 is coupled to the pump 602 and is configured to direct the movement of air in and out of the adjustable element 612. The control system 606 may comprise an Arduino controller. Alternatively, the control system 606 may comprise a Raspberry Pi, BeagleBone, Sharks Cove, Minnowboard MAX, Nanode, Waspmote, LittleBits or other type of controller.

The power source 608 is coupled to the control system 606. The power source 608 may include one or more internal batteries, external batteries, capacitors, fuel cells, AC power sources, DC power sources, or any other power source(s).

In some examples, the adjustable element 612 includes one or more temperature sensor(s) 614. The temperature sensor(s) 614 may be located within the adjustable element 612 or on an outer surface of the adjustable element 612 (e.g., on the top surface of the adjustable element 612 or the bottom surface of the adjustable element 612). The temperature sensor(s) 614 enable the user to control the temperature of the mattress 102 through one or more heating and/or cooling elements 616. These heating and/or cooling elements 616 may be implemented into each adjustable element 612 individually, or may be associated with multiple adjustable elements and/or sections of the mattress 102 itself (e.g., the top surface 620 or the bottom surface 622).

In some examples, the mattress 102 may include sensors to monitor the user's vitals (heart rate, temperature, blood pressure, breathing, position and limb movements) for the purpose of adjusting the sleep surface to improve sleep quality. For example, the mattress 102 may detect the user is experiencing difficulty with breathing and automatically activate one or more adjustable elements in order to put the user in a sitting position.

The top surface 620 and the bottom surface 622 may comprise of a cushioning material. For example, the cushioning material may be foam and/or gel. The cushioning material may be thicker in some areas that others, or it may be uniform along the mattress 102. In some examples, the top surface 620 is thicker than the bottom surface 622 or vice versa.

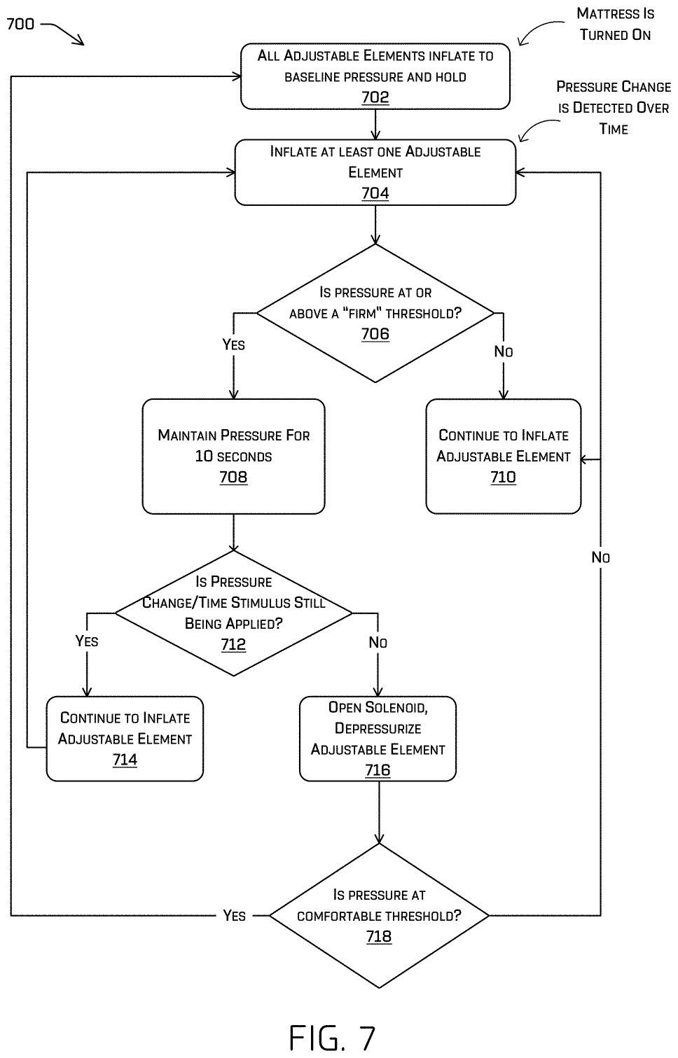

FIG. 7 is a flow chart illustrating an example process 700 for employing the techniques described herein. The example process 700 includes one or more adjustable elements. In some examples, operations described below can be performed by a user and/or operator of the adjustable mattress.

At 702, all adjustable elements inflate to a baseline pressure and can maintain that baseline pressure.

At 704, at least one adjustable element is inflated.

At 706, the internal pressure of the at least one adjustable element is measured. The internal pressure of the at least one adjustable element is determined to be at or above a firm threshold. The firm threshold may be determined by the user through user settings in the user interface.

At 708, the internal pressure of the at least one adjustable element is maintained for 10 seconds.

At 710, the internal pressure of the at least one adjustable element is determined to be below the firm threshold and the adjustable element may continue to inflate.

At 712, the pressure change/time stimulus may still be applied.

At 714, the at least one adjustable element may continue to inflate.

At 716, the solenoid valve may be opened to depressurize the at least one adjustable element.

At 718, the internal pressure of the at least one adjustable element is measured. In one example, the internal pressure of the at least one adjustable element is determined to be at a comfort threshold level. Comfort threshold level may be selected by the user, or may be determined by monitoring user behavior over time, or by measuring user vitals and using machine learning to select the optimal firmness setting. The at least one adjustable element may continue to maintain this level of pressure. In another example, the internal pressure of the at least one adjustable element is determined to be below the comfortable threshold and the at least one adjustable element may continue to inflate until the internal pressure is at or below a firm threshold.

FIG. 8 illustrates an example roll assist mechanism 800. The roll assist mechanism 800 may include at least three rows of adjustable elements, depicted in FIG. 8 as elements 806, 808, and 810. A patient 802 may lay on a top surface 804. One or more adjustable elements may comprise a first row of adjustable elements 806. The first row of adjustable elements 806 may be associated with a first portion of the top surface 804 disposed directly above the first row of adjustable elements 806. The second row (or middle row) of adjustable elements 808 may be associated with a second portion of the top surface 804 disposed directly above the second row of adjustable elements 808. The third row of adjustable elements 810 may be associated with a third portion of the top surface 804 disposed directly above the third row of adjustable elements 810.

In one example, a user or patient 802 is able to enact a roll assist movement or mechanism of a mattress so that a patient 802 is able to roll over on his or her side. In some examples, the user is the patient 802. In some examples, the roll assist movement or mechanism of the mattress is set to automatically repeat after a given time (e.g., every 15 minutes). In some examples, the mattress is set to automatically complete the roll assist movement or mechanism at a certain time and/or day (e.g. at 9 am on Monday and at 10 am on Saturday). When the roll assist mechanism is initiated, the first row of adjustable elements 806 and the third row of adjustable elements 810 are inflated, while the second row (or middle row) of adjustable elements 808 is deflated in order to catch the shoulder of the patient 802.

In some examples, the roll assist mechanism involves more than three rows of adjustable elements. For examples, the roll assist mechanism may work with four, five, six, or more rows of adjustable elements.

Although embodiments have been described in language specific to structural features and/or methodological acts, it is to be understood that the disclosure is not necessarily limited to specific features or acts described. Rather, the specific features and acts are disclosed herein as illustrative forms of implementing the embodiments.

We claim:

1. A system comprising:
a mattress having a top surface and a bottom surface;
a plurality of inflatable cells disposed below the top surface, the plurality of inflatable cells each having a bellowed structure;
a pump fluidly coupled to the plurality of inflatable cells;
a controller configured to control the mattress, the controller comprising:
a user interface;
one or more processors;
one or more computer-readable media storing instructions that, when executed by the one or more processors, configure the system to perform operations comprising:
receiving a request to adjust a characteristic of at least one of the plurality of inflatable cells; and
adjusting the characteristic of the at least one of the plurality of inflatable cells.

2. The system of claim 1, wherein the user interface displays a placement of the plurality of inflatable cells of the mattress.

3. The system of claim 1, wherein the characteristic comprises a temperature and/or a pressure.

4. The system of claim 1, further comprising a microphone configured to receive voice commands, the microphone being electrically coupled to the one or more processors.

5. A mattress comprising:
a mattress body having a top surface and a bottom surface; and
multiple adjustable elements disposed below the top surface, each adjustable element of the multiple adjustable elements being about 10 inches long and 10 inches wide, the multiple adjustable elements including:
a first adjustable element associated with a first portion of the top surface to adjust a characteristic of the mattress body proximate the first portion; and
a second adjustable element associated with a second portion of the top surface to adjust the characteristic of the mattress body proximate the second portion.

6. The mattress of claim 5, further comprising a pump fluidly connected to at least one of the first adjustable element or the second adjustable element.

7. The mattress of claim 5, wherein the multiple adjustable elements comprise at least 24 adjustable elements and at most 50 adjustable elements.

8. The mattress of claim 5, wherein the characteristic comprises at least one of height or firmness of respective portions of the mattress.

9. The mattress of claim 5, wherein the multiple adjustable elements comprise cells configured to change at least one of shape or size responsive to pressurizable fluid.

10. The mattress of claim 9, wherein the pressurizable fluid is a gas.

11. The mattress of claim 9, wherein the pressurizable fluid is a liquid.

12. The mattress of claim 5, wherein individual ones of the multiple adjustable elements comprise a bellows to contain fluid.

13. The mattress of claim 5, further comprising a communication connection configured to connect to a network and to be controlled by a remote computing device.

14. The mattress of claim 5, further comprising a controller configured to control the mattress, the controller comprising:
a user interface;
one or more processors;
one or more computer-readable media storing instructions that, when executed by the one or more processors, configure the mattress to perform operations comprising:
receiving sensor data associated with a characteristic of at least one adjustable element of the multiple adjustable elements; and
adjusting the characteristic of the at least one adjustable element of the multiple adjustable elements.

15. The mattress of claim 5, further comprising:
a temperature sensor to measure temperature of at least a portion of the mattress; and
at least one heating and/or cooling element coupled to the mattress and configured to change a temperature of at least a portion of the mattress.

16. A mattress comprising:
a mattress body having a top surface and a bottom surface;
multiple adjustable elements disposed below the top surface, the multiple adjustable elements including at least 24 adjustable elements, the multiple adjustable elements being disposed in at least three rows;
a controller configured to control the mattress, the controller comprising:
a user interface;
one or more processors;
one or more computer-readable media storing instructions that, when executed by the one or more processors, configure the mattress to perform acts comprising:
receiving a request to adjust a characteristic of at least one adjustable element of the 24 adjustable elements; and
adjusting the characteristic of the at least one adjustable element of the 24 adjustable elements.

17. The mattress of claim 16, the acts further comprising:
receiving a command to initiate a roll assist mechanism; and
causing a first row and a third row to inflate and a middle row to deflate.

18. The mattress of claim 17, wherein the roll assist mechanism of the mattress is set to automatically occur at a set time or set to automatically repeat after a period of time.

19. The mattress of claim 16, wherein the 24 adjustable elements each comprises a bellows structure and has one or more structural supports.

20. The mattress of claim 16, further comprising a communication connection configured to connect to a network to receive instructions from a remote computing device.
